(19) United States
(12) Patent Application Publication
(10) Pub. No.: US 2018/0243798 A1
(43) Pub. Date: Aug. 30, 2018

(54) Closed-Loop Centrifugal Air Classifying System and Method for Utilizing the Same

(71) Applicant: Edw. C. Levy Co., Detroit, MI (US)

(72) Inventors: Mark Andrew Abraham, Valparaiso, IN (US); Alton Leo Popp, Trenton, MI (US)

(21) Appl. No.: 15/549,003

(22) PCT Filed: Feb. 4, 2016
(86) PCT No.: PCT/US16/16596

§ 371 Date: Aug. 4, 2017

Related U.S. Application Data
(60) Provisional application No. 62/112,831, filed on Feb. 6, 2015.

(51) Int. Cl. B07B 7/10; B02C 23/12; B07B 7/083; B02C 23/18

(52) U.S. Cl. CPC B07B 7/10; B02C 23/18; B07B 7/083; B02C 23/12

(57) ABSTRACT

A method is disclosed. The method includes depositing a source material (M) consisting of blast furnace slag into a closed-loop centrifugal air classifying system (10, 10′, 10″) and utilizing the closed-loop centrifugal air classifying system (10, 10′, 10″) for processing the blast furnace slag into a processed blast furnace slag material (Mp). A closed-loop centrifugal air classifying system (10, 10′, 10″) is also disclosed.

### CROSS REFERENCE TO RELATED APPLICATION

This PCT application claims priority to U.S. Application No. 62/112,831 filed on Feb. 6, 2015. The entire contents of the aforementioned application is incorporated herein by reference in its entirety.

### FIELD OF THE INVENTION

The disclosure relates to a closed-loop centrifugal air classifying system and method for utilizing the same.

### DESCRIPTION OF THE RELATED ART

Improvements to closed-loop centrifugal air classifying system are continuously being sought in order to advance the arts.

### BRIEF DESCRIPTION OF THE DRAWINGS

The disclosure will now be described, by way of example, with reference to the accompanying drawings, in which:

FIG. 1 is a view of an exemplary closed-loop centrifugal air classifying system in accordance with an exemplary embodiment of the invention.

FIG. 2 is a view of an exemplary closed-loop centrifugal air classifying system in accordance with an exemplary embodiment of the invention.

FIG. 3 is a view of an exemplary closed-loop centrifugal air classifying system in accordance with an exemplary embodiment of the invention.

### SUMMARY

One aspect of the disclosure provides a method including the steps of depositing a source material consisting of blast furnace slag into a closed-loop centrifugal air classifying system; and utilizing the closed-loop centrifugal air classifying system for processing the blast furnace slag into a processed blast furnace slag material.

In some implementations, the method includes: prior to the depositing step, procuring the source material defined by one or more particles of blast furnace slag between approximately 0.1 microns and 5000 microns.

In some examples, particles of the processed blast furnace slag material ranges between approximately 0.1 microns and approximately 5000 microns.

In some instances, particles of the processed blast furnace slag material ranges between approximately 0.1 microns and approximately 800 microns.

In some implementations, particles of the processed blast furnace slag material ranges between approximately 0.1 microns and approximately 1000 microns.

In some examples, particles of the processed blast furnace slag material ranges between approximately 0.1 microns and approximately 1200 microns.

Another aspect of the disclosure provides a closed-loop centrifugal air classifying system. The system includes a classifier and vertical grinding mill, a cyclone collector, a fan and a hot air source. The cyclone collector is fluidly connected to the classifier and vertical grinding mill by a first duct segment of a plurality of duct segments. The fan is fluidly connected to the cyclone collector by a second duct segment of a plurality of duct segments. The fan is fluidly connected to the classifier and vertical grinding mill by a third duct segment of a plurality of duct segments. The hot air source is fluidly connected to one of the classifier and vertical grinding mill and the cyclone collector.

In some implementations, the hot air source is directly fluidly connected to the classifier and vertical grinding mill by a conduit.

In some examples, the classifier and vertical grinding mill forms a material entry opening.

In some instances, the cyclone collector forms a material exit opening.

In some implementations, the cyclone collector forms a material entry opening and a material exit opening.

In some examples, the hot air source is directly fluidly connected to the first duct segment of the plurality of duct segments by a conduit.

In some instances, the system also includes a coarse material conduit having a first end and a second end. The first end of the coarse material conduit is connected to the cyclone collector. The second end of the coarse material conduit is connected to the classifier and vertical grinding mill. The cyclone collector is elevated above the classifier and vertical grinding mill.

In some implementations, the system also includes a flash dryer connected to the material entry opening formed by the cyclone collector. The flash dryer includes a vertical shaft. The hot air source is directly fluidly connected to the vertical shaft by a conduit.

In some examples, the system also includes a first coarse material conduit and a second coarse material conduit. A first end of the first coarse material conduit is connected to the cyclone collector. A second end of the first coarse material conduit is connected to the classifier and vertical grinding mill. The first end of the second coarse material conduit is connected to an exit opening formed in the lower end of the vertical shaft of the flash dryer. A second end of the second coarse material conduit is connected to the first coarse material conduit. Both of the cyclone collector and the flash dryer are elevated above the classifier and vertical grinding mill.

In yet another aspect of the disclosure provides a method including the step of depositing a source material into a material entry opening of a closed-loop centrifugal air classifying system. The material entry opening is formed by one of a classifier and vertical grinding mill and a cyclone collector of the closed-loop centrifugal air classifying system. The method further includes the step of fluidly connecting a hot air source to one of the classifier and vertical grinding mill and the cyclone collector for: decreasing density of air within the closed-loop centrifugal air classifying system; drying the source material that is located within the closed-loop centrifugal air classifying system; utilizing the closed-loop centrifugal air classifying system for processing the source material into processed material; and recovering the processed material from a material exit opening formed by the cyclone collector.

In some implementations, the fluidly connecting step includes directly fluidly connecting the hot air source to the classifier and vertical grinding mill by a conduit.

In some examples, the classifier and vertical grinding mill forms the material entry opening. The cyclone collector forms a material exit opening.

In some instances, the cyclone collector forms the material entry opening and the material exit opening.

In some implementations, the fluidly connecting step includes directly fluidly connecting a hot air source to a duct segment that fluidly connects the classifier and vertical grinding mill to the cyclone collector.

In some examples, the method further includes: connecting a first end of a coarse material conduit to the cyclone collector; connecting a second end of the coarse material conduit to the classifier and vertical grinding mill; arranging the cyclone collector at an elevation above the classifier and vertical grinding mill; and directing some of the source material deposited into the material entry opening formed by the cyclone collector into the first end of the coarse material conduit for subsequent evacuation out of the second end of the coarse material conduit and into the classifier and vertical grinding mill.

In some instances, the method further includes: connecting a first end of the first coarse material conduit to the cyclone collector; connecting a second end of the first coarse material conduit to the classifier and vertical grinding mill; connecting a first end of the second coarse material conduit to an exit opening formed in the lower end of a vertical shaft of a flash dryer; connecting a second end of the second coarse material conduit to the first coarse material conduit; arranging both of the cyclone collector and the flash dryer at an elevation above the classifier and vertical grinding mill.

In some implementations, the method further includes: connecting the flash dryer to the material entry opening formed by the cyclone collector. The fluidly connecting step includes directly fluidly connecting the hot air source to the vertical shaft of the flash dryer such that the hot air source is indirectly fluidly connected to the cyclone collector. The method further includes the step of drying at least some of the source material deposited into the flash dryer by way of a flash dryer material opening formed by the flash dryer.

In some examples, the method further includes: directing a first portion of the source material that was dried by the flash dryer into the material entry opening formed by the cyclone collector; directing a classified portion of the first portion of the source material out of the material exit opening formed by the cyclone collector as the processed material; directing a rejected portion of the first portion of the source material from the cyclone collector into the first end of the coarse material conduit for subsequent evacuation out of the second end of the first coarse material conduit and into the classifier and vertical grinding mill; and directing a second portion of the source material within the flash dryer into the second coarse material conduit for subsequent evacuation out of the second end of the second coarse material conduit and into the first coarse material conduit for subsequent evacuation out of the second end of the first course material conduit and into the classifier and vertical grinding mill.

In some instances, the source material consists of blast furnace slag. The processed material consists of processed blast furnace slag material.

In some implementations, prior to the depositing step, the method further includes the step of: procuring the source material defined by one or more particles of blast furnace slag between approximately 0.1 microns and 5000 microns.

In some examples, particles of the processed blast furnace slag material ranges between approximately 0.1 microns and approximately 5000 microns.

In some instances, particles of the processed blast furnace slag material ranges between approximately 0.1 microns and approximately 800 microns.

In some implementations, particles of the processed blast furnace slag material ranges between approximately 0.1 microns and approximately 1000 microns.

In some examples, particles of the processed blast furnace slag material ranges between approximately 0.1 microns and approximately 1200 microns.

### DETAILED DESCRIPTION OF THE INVENTION

The Figures illustrate exemplary embodiments of closed-loop centrifugal air classifying systems. Based on the foregoing, it is to be generally understood that the nomenclature used herein is simply for convenience and the terms used to describe the invention should be given the broadest meaning by one of ordinary skill in the art.

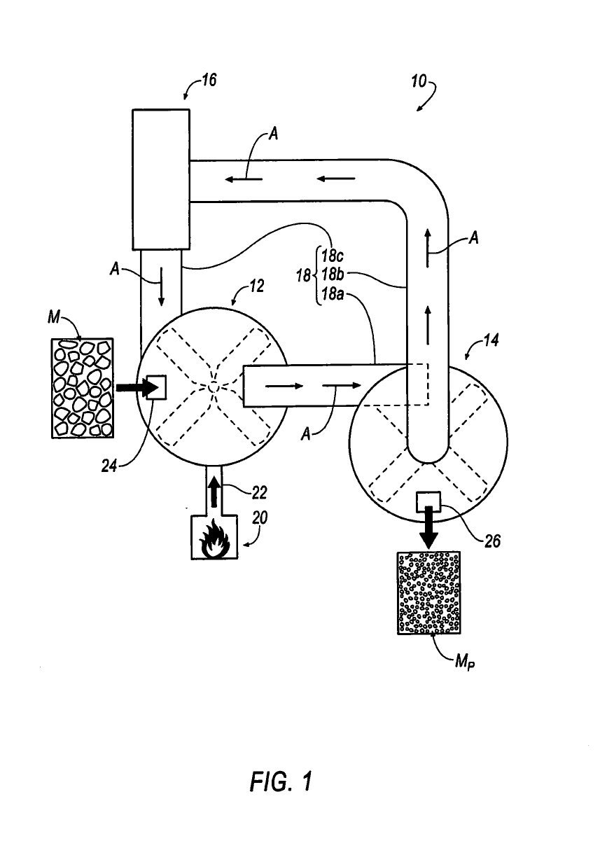

Referring to FIG. 1, an exemplary closed-loop centrifugal air classifying system is shown generally at 10. The closed-loop centrifugal air classifying system 10 includes a classifier and vertical grinding mill 12, a cyclone collector 14 and a fan 16. The classifier and vertical grinding mill 12, cyclone collector 14 and fan 16 are fluidly-connected to one another in a closed-loop arrangement by a plurality of duct segments 18.

The classifier and vertical grinding mill 12 is fluidly connected to the cyclone collector 14 by a first duct segment 18a of the plurality of duct segments 18. The cyclone collector 14 is fluidly connected to the fan 16 by a second duct segment 18b of the plurality of duct segments 18. The fan 16 is fluidly connected to the classifier and vertical grinding mill 12 by a third duct segment 18c of the plurality of duct segments 18.

The closed-loop centrifugal air classifying system 10 also includes a hot air source 20. The hot air source 20 is fluidly connected to the classifier and vertical grinding mill 12 by a conduit 22 (e.g., a duct). The hot air source 20 may include any desirable heat source. In an example, the hot air source 20 may include a flame that is fueled by a supply of natural gas. The hot air produced by the flame may be directly supplied to the classifier and vertical grinding mill 12 by the conduit 22.

A material entry opening 24 is formed in the classifier and vertical grinding mill 12. Also, a material exit opening 26 is formed in the cyclone collector 14. Source material, M, is deposited into the material entry opening 24. The closed-loop centrifugal air classifying system 10 processes the source material, M, into order to yield processed material, M_{P}. The processed material, M_{P}, may be recovered from the closed-loop centrifugal air classifying system 10 at the material exit opening 26.

Inclusion of the hot air source 20 in the closed-loop centrifugal air classifying system 10 yields several benefits. Firstly, inclusion of the hot air source 20 permits the source material, M, to be simultaneously crushed and dried; as a result, additional rotating equipment (for agitating the source material, M, within, for example, the classifier and vertical grinding mill 12) may be obviated. Furthermore, inclusion of the hot air source 20 in the closed-loop centrifugal air classifying system 10 decreases the density of the air in the closed-loop centrifugal air classifying system 10, which decreases the electrical energy consumed by the fan 16.

The source material, M, is blast furnace slag. In some instances, the blast furnace slag, M, is granulated. In other instances, the blast furnace slag, M, is air-cooled. The processed blast furnace slag, M_{P}, includes finer or lighter particles ranging between approximately 0.1 microns and 5000 microns. In some examples, the processed blast furnace slag, M_{P}, may be approximately equal to 800 microns. The processed blast furnace slag, M_{P}, may be utilized in the production of: glass, glass products, ceramics, refractories (e.g., an alumina or ceramic material that may be in: (1) brick form, (2) sprayable in the form of a concrete-like material or (3) poured (cast) in place as a concrete-like material), feed stock for pelletizing (e.g., the formation of small round pellets by agglomerating a fine powder with a binder like water, sugars, or other organic materials such as, for example, molasses), agricultural sand (e.g., fertilizer or nutrients), blast sand (that may be used in blast cleaning and in the abrasives industry), concrete block, construction materials (such as, for example, raw feed for a cement kiln to produce Portland cement clinker) and roofing granules.

In some instances, the classifier and vertical grinding mill 12 includes an upper main classifying or rejector chamber and rotor assembly formed of a generally cylindrical rejector chamber portion and an upwardly projecting cylindrical rotor support housing portion assembled with a downwardly converging conical expansion chamber classifier. The downwardly converging conical expansion chamber classifier forms a lower portion of the classifier and vertical grinding mill 12 and provides an expansion chamber for collecting coarser or heavier particles of the source material, M, which have been rejected from the upper rejector section.

The classifier and vertical grinding mill 12 includes a rotating vertical tapered blade rotor assembly having tapered blades. The rotor assembly causes greater air flow at the top of the downwardly converging conical expansion chamber classifier than at the bottom, which results in the source material, M, to be classified being held in suspension around the rotor by an upward column of air. The centrifugal spin of the upward column of air causes coarser or heavier particles of the source material, M, to be on the outside of the spin and the finer or lighter particles (e.g., the processed material, M_{P}) to be directed toward the center. Increasing the speed of the rotor assembly permits an increase of the resistance of the upcoming air or a decrease in the velocity of the air moving across the rotor assembly, which causes the source material, M, taken through the classifier and vertical grinding mill 12 to be finer or lighter because the transport velocity is being decreased. When the rotor assembly speed is decreased, the transport velocity is increased across the rotor assembly, allowing it to take the coarser or heavier particles of the source material, M, inwardly toward the center. The finer or lighter particles, M_{P}, of the source material, M, are then directed upwardly and toward a first end of the of the first duct segment 18a whereas the coarser or heavier particles of the source material, M, remain within the classifier and vertical grinding mill 12.

An upper end of the classifier and vertical grinding mill 12 is connected to the cyclone collector 14 by the first duct segment 18a. As the classifier and vertical grinding mill 12 processes the source material, M, as described above, the finer or lighter particles, M_{P}, that have passed through the classifier and vertical grinding mill 12 are transported along the closed-loop airstream, A, that travels through the first duct segment 18a and toward the cyclone collector 14. The cyclone collector 14 may include a screw top shape so as to force the closed-loop airstream, A, carrying the finer or lighter particles, M_{P}, in a downwardly spiraling direction. A pressure drop and decreasing velocity at the upper portion of the cyclone collector 14 allows the finer or lighter particles, M_{P}, to fall out of the closed-loop airstream, A, as the air is pushed downward. The spinning air in the cyclone collector 14 causes the finer or lighter particles, M_{P}, to be held to the outside portion of the cyclone collector 14 so that as the finer or lighter particles, M_{P}, are pushed down to a discharge point (e.g., the material exit opening 26) of the cyclone collector 14, the finer or lighter particles, M_{P}, are dropped out as they enter a lower end of the cyclone collector 14.

A vortex of clean air then moves upwardly through the cyclone collector 14 to a first end of the second duct segment 18b that is connected to an upper end of the cyclone collector 14. A second end of the second duct segment 18b is connected to the fan 16 for directing the clean air of the closed-loop airstream, A, from the cyclone collector 14 to the fan 16. The fan 16 may be driven by a motor. Rotation of the fan 16 imparted by the fan motor directs the clean air of the closed-loop airstream, A, into a first end of the third duct segment 18c such that the clean air of the closed-loop airstream, A, may be directed into the classifier and vertical grinding mill 12 at a second end of the third duct segment 18c.

Although the exemplary closed-loop centrifugal air classifying system 10 is described to include components such as the classifier and vertical grinding mill 12, the cyclone collector 14 and fan 16, the exemplary closed-loop centrifugal air classifying system 10 is not limited to such components. For example, a component other than the classifier and vertical grinding mill 12 may be incorporated for the purpose of reducing the size of the source material, M; such an exemplary component may include, for example, a ball mill (not shown). Unlike the classifier and vertical grinding mill 12, a ball mill does not have a rejector fan; as a result, classification of the source material, M, would not occur inside the ball mill. Therefore, because a ball mill does not include an “internal classifier,” classification of the source material, M, occurs outside of the ball mill within one or several cyclone collectors.

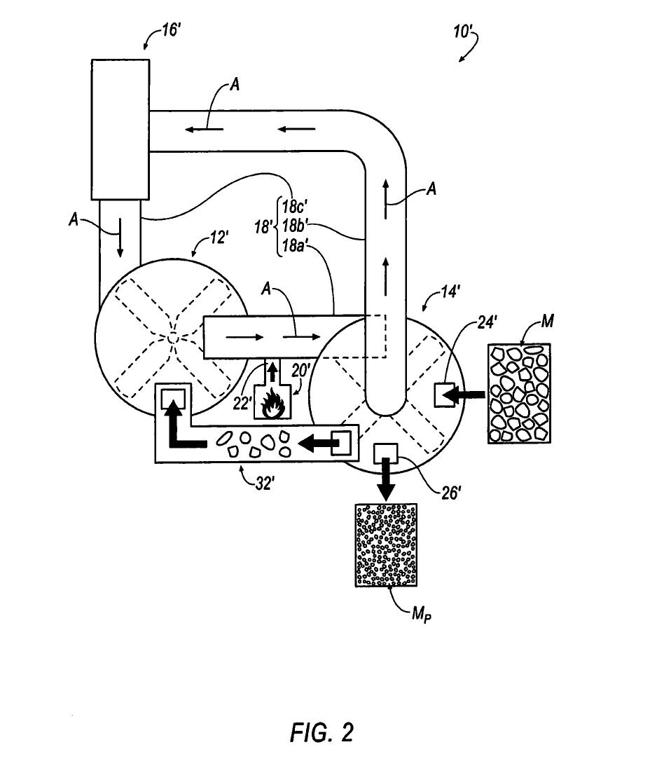

Referring to FIG. 2, an exemplary closed-loop centrifugal air classifying system is shown generally at 10′. The closed-loop centrifugal air classifying system 10′ includes a classifier and vertical grinding mill 12′, a cyclone collector 14′ and a fan 16′. The classifier and vertical grinding mill 12′, cyclone collector 14′ and fan 16′ are fluidly-connected to one another in a closed-loop arrangement by a plurality of duct segments 18′.

The classifier and vertical grinding mill 12′ is fluidly connected to the cyclone collector 14′ by a first duct segment 18a′ of the plurality of duct segments 18′. The cyclone collector 14′ is fluidly connected to the fan 16′ by a second duct segment 18b′ of the plurality of duct segments 18′. The fan 16′ is fluidly connected to the classifier and vertical grinding mill 12′ by a third duct segment 18c′ of the plurality of duct segments 18′.

The closed-loop centrifugal air classifying system 10′ also includes a hot air source 20′. The hot air source 20′ is fluidly connected to the first duct segment 18a′ of the plurality of duct segments 18′ by a conduit 22′ (e.g., a duct). The hot air source 20′ may include any desirable heat source. In an example, the hot air source 20′ may include a flame that is fueled by a supply of natural gas. The hot air produced by the flame may be directly supplied to the first duct segment 18a′ by the conduit 22′.

Inclusion of the hot air source 20′ in the closed-loop centrifugal air classifying system 10′ yields several benefits. Firstly, inclusion of the hot air source 20′ permits the source material, M, that is fed from the classifier and vertical grinding mill 12′ through the first duct segment 18a′ and into the cyclone collector 14′ to be simultaneously classified and dried. Furthermore, inclusion of the hot air source 20′ lowers the density of the air in the cyclone collector 14′ thereby increasing the classifying efficiency of the cyclone collector 14′.

The cyclone collector 14′ forms a material entry opening 24′. The cyclone collector 14′ also forms a material exit opening 26′. Source material, M, is deposited into the material entry opening 24′. The closed-loop centrifugal air classifying system 10′ processes the source material, M, into order to yield processed material, M_{P}. The processed material, M_{P}, may be recovered from the closed-loop centrifugal air classifying system 10′ at the material exit opening 26′.

The closed-loop centrifugal air classifying system 10′ also includes a coarse material conduit 32′. A first end of the coarse material conduit 32′ is connected to the cyclone collector 14′, and, a second end of the coarse material conduit 32′ is connected to the classifier and vertical grinding mill 12′. By arranging the material entry opening 24′ at the cyclone collector 14′ (rather than at the classifier and vertical grinding mill 12 as described above in FIG. 1), the source material, M, may be classified before being directed to the classifier and vertical grinding mill 12′. By processing the source material, M, in such an order, a portion of the source material, M, that is already suitably-sized as processed material, M_{P}, may remain in the cyclone collector 14′, and, as a result, over-grinding of such material is avoided. Furthermore, because a portion of the source, M, may be distinguished as suitably-sized processed material, M_{P}, at a much earlier stage within the closed-loop centrifugal air classifying system 10′ (when compared to the closed-loop centrifugal air classifying system 10 of FIG. 1), the closed-loop centrifugal air classifying system 10′ may include a smaller/less costly classifier and vertical grinding mill 12′ (or the potential throughput of the classifier and vertical grinding mill 12′ may be increased) in comparison to the classifier and vertical grinding mill 12 of FIG. 1. Additionally, because the closed-loop centrifugal air classifying system 10′ avoids the potential for over-grinding the source material, M, the processed material, M_{P}, may be characterized as having improved quality such as, for example: an improved flow rate out of storage bins, truck and rail cars due to the fact that the processed material, M_{P}, is less likely to be finer than 150 microns.

The source material, M, is blast furnace slag. In some instances, the blast furnace slag, M, is granulated. In other instances, the blast furnace slag, M, is air-cooled. The processed blast furnace slag, M_{P}, includes finer or lighter particles ranging between approximately 0.1 microns and 5000 microns. In some example, the processed blast furnace slag, M_{P}, may be approximately equal to 800 microns, 1000 microns or 1200 microns. The processed blast furnace slag, M_{P}, may be utilized in the production of: glass, glass products, ceramics, refractories (e.g., an alumina or ceramic material that may be in: (1) brick form, (2) sprayable in the form of a concrete-like material or (3) poured (cast) in place as a concrete-like material), feed stock for pelletizing (e.g., the formation of small round pellets by agglomerating a fine powder with a binder like water, sugars, or other organic materials such as, for example, molasses), agricultural sand (e.g., fertilizer or nutrients), blast sand (that may be used in blast cleaning and in the abrasives industry), concrete block, construction materials (such as, for example, raw feed for a cement kiln to produce Portland cement clinker) and roofing granules.

When the source material, M, is initially deposited within the cyclone collector 14′, it should be noted that the cyclone collector 14′ is elevated above the classifier and vertical grinding mill 12′ such that coarser or heavier particles of the source material, M, fall (with the assistance of gravity) out of a lower end of the cyclone collector 14′ and into the coarse material conduit 32′ for subsequent arrival within the classifier and vertical grinding mill 12′. In some instances, the classifier and vertical grinding mill 12′ includes an upper main classifying or rejector chamber and rotor assembly formed of a generally cylindrical rejector chamber portion and an upwardly projecting cylindrical rotor support housing portion assembled with a downwardly converging conical expansion chamber classifier. The downwardly converging conical expansion chamber classifier forms a lower portion of the classifier and vertical grinding mill 12′ and provides an expansion chamber for collecting coarser or heavier particles of the source material, M, which have been rejected from the upper rejector section.

The classifier and vertical grinding mill 12′ includes a rotating vertical tapered blade rotor assembly having tapered blades. The rotor assembly causes greater air flow at the top of the downwardly converging conical expansion chamber classifier than at the bottom, which results in the source material, M, to be classified being held in suspension around the rotor by an upward column of air. The centrifugal spin of the upward column of air causes coarser or heavier particles of the source material, M, to be on the outside of the spin and the finer or lighter particles (e.g., the processed material, M_{P}) to be directed toward the center. Increasing the speed of the rotor assembly permits an increase of the resistance of the upcoming air or a decrease in the velocity of the air moving across the rotor assembly, which causes the source material, M, taken through the classifier and vertical grinding mill 12′ to be finer or lighter because the transport velocity is being decreased. When the rotor assembly speed is decreased, the transport velocity is increased across the rotor assembly, allowing it to take the coarser or heavier particles of the source material, M, inwardly toward the center. The finer or lighter particles, M_{P}, of the source material, M, are then directed upwardly and toward a first end of the of the first duct segment 18a′ whereas the coarser or heavier particles of the source material, M, remain within the classifier and vertical grinding mill 12′.

An upper end of the classifier and vertical grinding mill 12′ is connected to the cyclone collector 14′ by the first duct segment 18a′. As the classifier and vertical grinding mill 12′ processes the source material, M, as described above, the finer or lighter particles, M_{P}, that have passed through the classifier and vertical grinding mill 12′ are transported along the closed-loop airstream, A, that travels through the first duct segment 18a′ and toward the cyclone collector 14′. The cyclone collector 14′ may include a screw top shape so as to force the closed-loop airstream, A, carrying the finer or lighter particles, M_{P}, in a downwardly spiraling direction. A pressure drop and decreasing velocity at the upper portion of the cyclone collector 14′ allows the finer or lighter particles, M_{P}, to fall out of the closed-loop airstream, A, as the air is pushed downward. The spinning air in the cyclone collector 14′ causes the finer or lighter particles, M_{P}, to be held to the outside portion of the cyclone collector 14′ so that as the finer or lighter particles, M_{P}, are pushed down to a discharge point (e.g., the material exit opening 26′) of the cyclone collector 14′, the finer or lighter particles, M_{P}, are dropped out as they enter a lower end of the cyclone collector 14′.

A vortex of clean air then moves upwardly through the cyclone collector 14′ to a first end of the second duct segment 18b′ that is connected to an upper end of the cyclone collector 14′. A second end of the second duct segment 18b′ is connected to the fan 16′ for directing the clean air of the closed-loop airstream, A, from the cyclone collector to the fan 16′. The fan 16′ may be driven by a motor. Rotation of the fan 16′ imparted by the fan motor directs the clean air of the closed-loop airstream, A, into a first end of the third duct segment 18c′ such that the clean air of the closed-loop airstream, A, may be directed into the classifier and vertical grinding mill 12′ at a second end of the third duct segment 18c′.

Although the exemplary closed-loop centrifugal air classifying system 10′ is described to include components such as the classifier and vertical grinding mill 12′, the cyclone collector 14′ and fan 16′, the exemplary closed-loop centrifugal air classifying system 10′ is not limited to such components. For example, a component other than the classifier and vertical grinding mill 12′ may be incorporated for the purpose of reducing the size of the source material, M; such an exemplary component may include, for example, a ball mill (not shown). Unlike the classifier and vertical grinding mill 12′, a ball mill does not have a rejector fan; as a result, classification of the source material, M, would not occur inside the ball mill. Therefore, because a ball mill does not include an “internal classifier,” classification of the source material, M, occurs outside of the ball mill within one or several cyclone collectors.

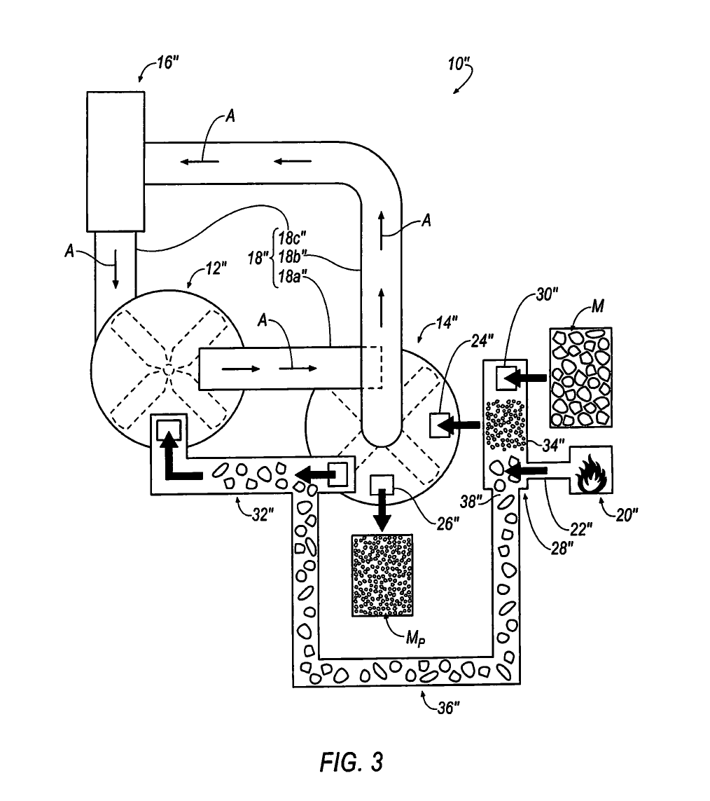

Referring to FIG. 3, an exemplary closed-loop centrifugal air classifying system is shown generally at 10″. The closed-loop centrifugal air classifying system 10″ includes a classifier and vertical grinding mill 12″, a cyclone collector 14″ and a fan 16″. The classifier and vertical grinding mill 12″, cyclone collector 14″ and fan 16″ are fluidly-connected to one another in a closed-loop arrangement by a plurality of duct segments 18″.

The classifier and vertical grinding mill 12″ is fluidly connected to the cyclone collector 14″ by a first duct segment 18a″ of the plurality of duct segments 18″. The cyclone collector 14″ is fluidly connected to the fan 16″ by a second duct segment 18b″ of the plurality of duct segments 18″. The fan 16″ is fluidly connected to the classifier and vertical grinding mill 12″ by a third duct segment 18c″ of the plurality of duct segments 18″.

The closed-loop centrifugal air classifying system 10″ also includes a hot air source 20″. A material entry opening 24″ is formed in the cyclone collector 14″. Also, also a material exit opening 26″ is formed in the cyclone collector 14″. The closed-loop centrifugal air classifying system 10″ also includes a flash dryer 28″. The flash dryer 28″ may include a flash dryer material opening 30″, a vertical shaft 34″ having an interior surface that is lined with refractory to reduce wear imparted thereto while also retaining heat generated by the hot air source 20″ that is located at the bottom of the vertical shaft.

The flash dryer 28″ is connected to the material entry opening 24″ formed by the cyclone collector 14″. The hot air source 20″ is fluidly connected to the flash dryer 28″ by a conduit 22″ (e.g., a duct). The hot air source 20″ may include any desirable heat source. In an example, the hot air source 20″ may include a flame that is fueled by a supply of natural gas. The hot air produced by the flame may be directly supplied to the flash dryer 28″ by the conduit 22′.

The closed-loop centrifugal air classifying system 10″ also includes a first coarse material conduit 32″. A first end of the first coarse material conduit 32″ is connected to the cyclone collector 14″, and, a second end of the first coarse material conduit 32″ is connected to the classifier and vertical grinding mill 12″. The closed-loop centrifugal air classifying system 10″ also includes a second coarse material conduit 36″. A first end of the second coarse material conduit 36″ is connected to the flash dryer 28″, and, a second end of the second coarse material conduit 36″ is connected to the first coarse material conduit 32″.

Inclusion of the hot air source 20″ and flash dryer 28″ in the closed-loop centrifugal air classifying system 10″ yields several benefits. As wet source material, M, is fed (at a rate controlled by a mechanism such as a screw feeder or rotary air lock that prevent fresh air from entering the material feed stream) into a flash dryer material opening 30″, the source material, M, is dried as it is blown upwardly, from a lower end of the vertical shaft 34″ toward material entry opening 24″ formed by the cyclone collector 14″. In some instances, the flash dryer 28″ may include an exit opening 38″ that is formed in the lower end of the vertical shaft 34″ and is in communication with the second course material conduit 36″ to permit large, oversized pieces of the source material, M (e.g., in the range of approximately 5000 microns to approximately 10,000 microns), to be evacuated from the flash dryer 28″ and into the first coarse material conduit 32″ for subsequent arrival at the classifier and vertical grinding mill 12″ if such oversized pieces of the source material, M, are not able to be forced upwardly within the vertical shaft 34″ with the hot air stream provided by the hot air source 20″. Some of the source material, M, that is not heavy/coarse (e.g., source material, M, that is less than approximately 5000 microns) will pneumatically arrive at the material entry opening 24″ (i.e., the carrying force of the hot air stream exceeds the force of gravity applied to the source material, M) with the hot air stream provided by the hot air source 20″ once the mass of such source material, M, is reduced (i.e., as a result of moisture contained therein being evaporated/dried off from the source material, M). Once the flash dryer 28″ has sufficiently dried (e.g., less than 0.5% moisture content by mass) the source material, M, such that the source material, M, is directed from the flash dryer 28″ and into the material entry opening 24″, the cyclone collector 14″ processes the dried source material, M, received from the flash dryer 28″ in order to yield processed material, M_{P}. The processed material, M_{P}, may be recovered from the closed-loop centrifugal air classifying system 10″ at the material exit opening 26″.

Therefore, as a result of the inclusion of the flash dryer 28″ in the closed-loop centrifugal air classifying system 10″, moisture included with the source material, M, is removed, which would otherwise cause source material particles to stick together, which may result in incorrect classification of sufficiently-sized, smaller particles of source material, M. When such particles are stuck together and incorrectly classified as a single, larger/course particle of source material, M, unnecessary grinding (and potentially re-grinding) of such source material, M, may take place, which not only undesirably would create finer particles of processed material, M_{P}, but, also, increases the length of time for processing the source material, M, into processed material, M_{P}.

The source material, M, is blast furnace slag. In some instances, the blast furnace slag, M, is granulated. In other instances, the blast furnace slag, M, is air-cooled. The processed blast furnace slag, M_{P}, includes finer or lighter particles ranging between approximately 0.1 microns and 5000 microns. In some example, the processed blast furnace slag, M_{P}, may be approximately equal to 800 microns. The processed blast furnace slag, M_{P}, may be utilized in the production of: glass, glass products, ceramics, refractories (e.g., an alumina or ceramic material that may be in: (1) brick form, (2) sprayable in the form of a concrete-like material or (3) poured (cast) in place as a concrete-like material), feed stock for pelletizing (e.g., the formation of small round pellets by agglomerating a fine powder with a binder like water, sugars, or other organic materials such as, for example, molasses), agricultural sand (e.g., fertilizer or nutrients), blast sand (that may be used in blast cleaning and in the abrasives industry), concrete block, construction materials (such as, for example, raw feed for a cement kiln to produce Portland cement clinker) and roofing granules.

When the source material, M, is initially deposited within the flash dryer 28″, it should be noted that the flash dryer 28″ is elevated above the classifier and vertical grinding mill 12″ such that coarser or heavier particles of the source material, M, fall (with the assistance of gravity) out of the exit opening 38″ formed by the vertical shaft 34″ of the flash dryer 28″ and into the second coarse material conduit 36″ for subsequent arrival within the classifier and vertical grinding mill 12″. Furthermore, some of source material, M, may be rejected by the cyclone collector 14″, and, similarly, it should be noted that the cyclone collector 14″ is elevated above the classifier and vertical grinding mill 12″ such that coarser or heavier particles of the source material, M, within the cyclone collector 14″ fall (with the assistance of gravity) out of a lower end of the cyclone collector 14″ and into the first coarse material conduit 32″ for subsequent arrival within the classifier and vertical grinding mill 12″.

In some instances, the classifier and vertical grinding mill 12″ includes an upper main classifying or rejector chamber and rotor assembly formed of a generally cylindrical rejector chamber portion and an upwardly projecting cylindrical rotor support housing portion assembled with a downwardly converging conical expansion chamber classifier. The downwardly converging conical expansion chamber classifier forms a lower portion of the classifier and vertical grinding mill 12″ and provides an expansion chamber for collecting coarser or heavier particles of the source material, M, which have been rejected from the upper rejector section.

The classifier and vertical grinding mill 12″ includes a rotating vertical tapered blade rotor assembly having tapered blades. The rotor assembly causes greater air flow at the top of the downwardly converging conical expansion chamber classifier than at the bottom, which results in the source material, M, to be classified being held in suspension around the rotor by an upward column of air. The centrifugal spin of the upward column of air causes coarser or heavier particles of the source material, M, to be on the outside of the spin and the finer or lighter particles (e.g., the processed material, M_{P}) to be directed toward the center. Increasing the speed of the rotor assembly permits an increase of the resistance of the upcoming air or a decrease in the velocity of the air moving across the rotor assembly, which causes the source material, M, taken through the classifier and vertical grinding mill 12″ to be finer or lighter because the transport velocity is being decreased. When the rotor assembly speed is decreased, the transport velocity is increased across the rotor assembly, allowing it to take the coarser or heavier particles of the source material, M, inwardly toward the center. The finer or lighter particles, M_{P}, of the source material, M, are then directed upwardly and toward a first end of the of the first duct segment 18a″ whereas the coarser or heavier particles of the source material, M, remain within the classifier and vertical grinding mill 12″.

An upper end of the classifier and vertical grinding mill 12″ is connected to the cyclone collector 14″ by the first duct segment 18a″. As the classifier and vertical grinding mill 12″ processes the source material, M, as described above, the finer or lighter particles, M_{P}, that has passed through the classifier and vertical grinding mill 12″ are transported along the closed-loop airstream, A, that travels through the first duct segment 18a″ and toward the cyclone collector 14″. The cyclone collector 14″ may include a screw top shape so as to force the closed-loop airstream, A, carrying the finer or lighter particles, M_{P}, in a downwardly spiraling direction. A pressure drop and decreasing velocity at the upper portion of the cyclone collector 14″ allows the finer or lighter particles, M_{P}, to fall out of the closed-loop airstream, A, as the air is pushed downward. The spinning air in the cyclone collector 14″ causes the finer or lighter particles, M_{P}, to be held to the outside portion of the cyclone collector 14″ so that as the finer or lighter particles, M_{P}, are pushed down to a discharge point (e.g., the material exit opening 26″) of the cyclone collector 14″, the finer or lighter particles, M_{P}, are dropped out as they enter a lower end of the cyclone collector 14″.

A vortex of clean air then moves upwardly through the cyclone collector 14″ to a first end of the second duct segment 18b″ that is connected to an upper end of the cyclone collector 14″. A second end of the second duct segment 18b″ is connected to the fan 16″ for directing the clean air of the closed-loop airstream, A, from the cyclone collector to the fan 16″. The fan 16″ may be driven by a motor. Rotation of the fan 16″ imparted by the fan motor directs the clean air of the closed-loop airstream, A, into a first end of the third duct segment 18c″ such that the clean air of the closed-loop airstream, A, may be directed into the classifier and vertical grinding mill 12″ at a second end of the third duct segment 18c″.

Although the exemplary closed-loop centrifugal air classifying system 10″ is described to include components such as the classifier and vertical grinding mill 12″, the cyclone collector 14″ and fan 16″, the exemplary closed-loop centrifugal air classifying system 10″ is not limited to such components. For example, a component other than the classifier and vertical grinding mill 12″ may be incorporated for the purpose of reducing the size of the source material, M; such an exemplary component may include, for example, a ball mill (not shown). Unlike the classifier and vertical grinding mill 12″, a ball mill does not have a rejector fan; as a result, classification of the source material, M, would not occur inside the ball mill. Therefore, because a ball mill does not include an “internal classifier,” classification of the source material, M, occurs outside of the ball mill within one or several cyclone collectors.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method, comprising:
depositing a source material consisting of blast furnace slag into a closed-loop centrifugal air classifying system; and
utilizing the closed-loop centrifugal air classifying system for processing the blast furnace slag into a processed blast furnace slag material.

2. The method according to claim 1, wherein, prior to the depositing step, the method further comprises the step of:
procuring the source material defined by one or more particles of blast furnace slag between approximately 0.1 microns and 5000 microns.

3. The method according to claim 1, wherein particles of the processed blast furnace slag material ranges between approximately 0.1 microns and approximately 5000 microns.

4. The method according to claim 1, wherein particles of the processed blast furnace slag material ranges between approximately 0.1 microns and approximately 800 microns.

5. The method according to claim 1, wherein particles of the processed blast furnace slag material ranges between approximately 0.1 microns and approximately 1000 microns.

6. The method according to claim 1, wherein particles of the processed blast furnace slag material ranges between approximately 0.1 microns and approximately 1200 microns.

7. A closed-loop centrifugal air classifying system, comprising:
a classifier and vertical grinding mill;
a cyclone collector fluidly connected to the classifier and vertical grinding mill by a first duct segment of a plurality of duct segments;
a fan fluidly connected to the cyclone collector by a second duct segment of a plurality of duct segments, wherein the fan is fluidly connected to the classifier and vertical grinding mill by a third duct segment of a plurality of duct segments; and
a hot air source fluidly connected to one of the classifier and vertical grinding mill and the cyclone collector.

8. The closed-loop centrifugal air classifying system according to claim 7, wherein the hot air source is directly fluidly connected to the classifier and vertical grinding mill by a conduit.

9. The closed-loop centrifugal air classifying system according to claim 8, wherein the classifier and vertical grinding mill forms a material entry opening.

10. The closed-loop centrifugal air classifying system according to claim 9, wherein the cyclone collector forms a material exit opening.

11. The closed-loop centrifugal air classifying system according to claim 7, wherein the cyclone collector forms a material entry opening and a material exit opening.

12. The closed-loop centrifugal air classifying system according to claim 11, wherein the hot air source is directly fluidly connected to the first duct segment of the plurality of duct segments by a conduit.

13. The closed-loop centrifugal air classifying system according to claim 12 further comprising:
a coarse material conduit having a first end and a second end, wherein the first end of the coarse material conduit is connected to the cyclone collector, wherein the second end of the coarse material conduit is connected to the classifier and vertical grinding mill, wherein the cyclone collector is elevated above the classifier and vertical grinding mill.

14. The closed-loop centrifugal air classifying system according to claim 11 further comprising:
a flash dryer connected to the material entry opening formed by the cyclone collector, wherein the flash dryer includes a vertical shaft, wherein the hot air source is directly fluidly connected to the vertical shaft by a conduit.

15. The closed-loop centrifugal air classifying system according to claim 14 further comprising:
a first coarse material conduit, and
a second coarse material conduit, wherein a first end of the first coarse material conduit is connected to the cyclone collector, wherein a second end of the first coarse material conduit is connected to the classifier and vertical grinding mill, wherein the first end of the second coarse material conduit is connected to an exit opening formed in the lower end of the vertical shaft of the flash dryer, wherein a second end of the second coarse material conduit is connected to the first coarse material conduit, wherein both of the cyclone collector and the flash dryer are elevated above the classifier and vertical grinding mill.

16. A method, comprising:
depositing a source material into a material entry opening of a closed-loop centrifugal air classifying system, wherein the material entry opening is formed by one of a classifier and vertical grinding mill and a cyclone collector of the closed-loop centrifugal air classifying system;
fluidly connecting a hot air source to one of the classifier and vertical grinding mill and the cyclone collector for
decreasing density of air within the closed-loop centrifugal air classifying system, and
drying the source material that is located within the closed-loop centrifugal air classifying system;
utilizing the closed-loop centrifugal air classifying system for processing the source material into processed material; and
recovering the processed material from a material exit opening formed by the cyclone collector.

17. The method according to claim 16, wherein the fluidly connecting step includes directly fluidly connecting the hot air source to the classifier and vertical grinding mill by a conduit.

18. The method according to claim 17, wherein the classifier and vertical grinding mill forms the material entry opening, wherein the cyclone collector forms a material exit opening.

19. The method according to claim 16, wherein the cyclone forms the material entry opening and the material exit opening.

20. The method according to claim 19, wherein the fluidly connecting step includes directly fluidly connecting a hot air source to a duct segment that fluidly connects the classifier and vertical grinding mill to the cyclone collector.

21. The method according to claim 20 further comprising:
connecting a first end of a coarse material conduit to the cyclone collector;
connecting a second end of the coarse material conduit to the classifier and vertical grinding mill;
arranging the cyclone collector at an elevation above the classifier and vertical grinding mill; and
directing some of the source material deposited into the material entry opening formed by the cyclone collector into the first end of the coarse material conduit for subsequent evacuation out of the second end of the coarse material conduit and into the classifier and vertical grinding mill.

22. The method according to claim 19 further comprising:
connecting a first end of the first coarse material conduit to the cyclone collector;
connecting a second end of the first coarse material conduit to the classifier and vertical grinding mill;
connecting a first end of the second coarse material conduit to an exit opening formed in the lower end of a vertical shaft of a flash dryer;
connecting a second end of the second coarse material conduit to the first coarse material conduit; and
arranging both of the cyclone collector and the flash dryer at an elevation above the classifier and vertical grinding mill.

23. The method according to claim 22 further comprising:
connecting the flash dryer to the material entry opening formed by the cyclone collector;
wherein the fluidly connecting step includes directly fluidly connecting the hot air source to the vertical shaft of the flash dryer such that the hot air source is indirectly fluidly connected to the cyclone collector; and
drying at least some of the source material deposited into the flash dryer by way of a flash dryer material opening formed by the flash dryer.

24. The method according to claim 23 further comprising:
directing a first portion of the source material that was dried by the flash dryer into the material entry opening formed by the cyclone collector;
directing a classified portion of the first portion of the source material out of the material exit opening formed by the cyclone collector as the processed material;
directing a rejected portion of the first portion of the source material from the cyclone collector into the first end of the coarse material conduit for subsequent evacuation out of the second end of the first coarse material conduit and into the classifier and vertical grinding mill; and
directing a second portion of the source material within the flash dryer into the second coarse material conduit for subsequent evacuation out of the second end of the second coarse material conduit and into the first coarse material conduit for subsequent evacuation out of the second end of the first course material conduit and into the classifier and vertical grinding mill.

25. The method according to claim 16, wherein the source material consists of blast furnace slag, wherein the processed material consists of processed blast furnace slag material.

26. The method according to claim 25, wherein, prior to the depositing step, the method further comprises the step of:
procuring the source material defined by one or more particles of blast furnace slag between approximately 0.1 microns and 5000 microns.

27. The method according to claim 25, wherein particles of the processed blast furnace slag material ranges between approximately 0.1 microns and approximately 5000 microns.

28. The method according to claim 25, wherein particles of the processed blast furnace slag material ranges between approximately 0.1 microns and approximately 800 microns.

29. The method according to claim 25, wherein particles of the processed blast furnace slag material ranges between approximately 0.1 microns and approximately 1000 microns.

30. The method according to claim 25, wherein particles of the processed blast furnace slag material ranges between approximately 0.1 microns and approximately 1200 microns.
